(19) United States
(12) Patent Application Publication
(10) Pub. No.: US 2009/0110974 A1
(43) Pub. Date: Apr. 30, 2009

(54) FLOW CHANNEL AND FUEL CELL SYSTEM

(76) Inventors: Seong-Kee Yoon, Suwon-si (KR); Sang-Jun Kong, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 12/171,126

(22) Filed: Jul. 10, 2008

(30) Foreign Application Priority Data
Oct. 30, 2007 (KR) 10-2007-0109802

(51) Int. Cl. H01M 8/18; H01M 2/00

(52) U.S. Cl. 429/19; 429/34

(57) ABSTRACT

A fuel cell system includes a fuel cell stack for generating electric energy by an electrochemical reaction of hydrogen and oxygen; a hydride tank for storing a liquid hydride; a liquid catalyst tank for storing a liquid catalyst for promoting a hydrogen gas generation reaction from the liquid hydride; a reaction flow channel for promoting laminar flow of the liquid hydride and the liquid catalyst; and a hydrogen separator for storing the hydrogen gas generated from the reaction flow channel and transferring the hydrogen gas to the fuel cell stack.

### CROSS-REFERENCE TO RELATED APPLICATIONS

This application claims priority to and the benefit of Korean Patent Application No. 10-2007-0109802 filed on Oct. 30, 2007, in the Korean Intellectual Property Office, the entire content of which is incorporated herein by reference.

### BACKGROUND

1. Field of the Invention

The present invention relates to a fuel cell system using a liquid hydride as a source of hydrogen fuel.

2. Discussion of Related Art

A fuel cell is a power generation system that generates electric energy by an electrochemical reaction of hydrogen and oxygen. There are several types of fuel cells, each using a different chemistry or electrolyte. Examples of different fuel cells include phosphoric acid fuel cells, molten carbonate fuel cells, solid oxide fuel cells, polymer electrolyte fuel cells, and alkaline fuel cells, etc. These fuel cells operate on the same general principle, but use different types of fuels, and have different operating temperatures, catalysts, and electrolytes, etc. Among the different fuel cells, polymer electrolyte membrane fuel cells (PEMFC) have a high output characteristic, and operate at a low operating temperature range. In addition, a PEMFC has rapid starting and response characteristics as compared to other kinds of fuel cells. Therefore, PEMFCs can be used in a variety of applications such as mobile power sources for portable electronic equipment, or transportable power sources for automobiles, as well as distributed power sources such as stationary power plants for houses and public buildings, etc.

Hydrogen has excellent reactivity in an electrochemical oxidation reaction occurred at an anode electrode of a fuel cell. Fuel cell systems using hydrogen as a fuel produce only water upon reacting with oxygen. Therefore, hydrogen is considered one of the most suitable fuels for fuel cells. However, pure hydrogen gas is not readily available. Hydrogen gas is often obtained by reforming other raw materials. For instance, methanol is typically used as a fuel as hydrogen can be easily produced at the anode electrode.

Fuel cell systems using hydrides such as NaBH₄, etc. have been proposed. Such fuel cell systems have high volume storage efficiency. Hydrides can be supplied to a fuel cell in a liquid form or can be used to generate hydrogen in a gaseous form that is supplied to the fuel cell. In the gaseous form, hydrogen gas is first generated from the hydrides through a chemical reaction, and then is fed to an anode electrode of a PEMFC stack.

Hydrides are compounds that produce hydrogen and heat upon reacting with water. Examples of different hydrides that can be used as a fuel include sodium borohydride (NaBH₄), lithium borohydride (LiBH₄), lithium hydride (LiH), sodium hydride (NaH), and combinations thereof.

Fuel cell systems using liquid hydrides as a fuel require mechanisms for transporting the liquid hydride, liquid catalyst, and fluids (by-products) created after chemical reactions. However, because liquid hydrides generally have a high viscosity, they can tend to slow down or even block the flow path.

### SUMMARY OF THE INVENTION

An embodiment of the present invention is directed toward a fuel cell system that includes a fuel cell stack for generating electric energy by an electrochemical reaction of hydrogen and oxygen; a hydride tank for storing a liquid hydride; a liquid catalyst tank for storing a liquid catalyst for promoting a reaction that generates hydrogen gas; and a reaction flow channel with at least one liquid catalyst inlet and at least one liquid hydride inlet adapted to promote laminar flow. The reaction flow channel is adapted to promote laminar flow of the liquid hydride and the liquid catalyst and generate hydrogen gas by a reaction between the liquid hydride and liquid catalyst. The fuel cell system may further include and a hydrogen separator for storing the hydrogen gas generated from the reaction flow channel and for transferring the hydrogen gas to the fuel cell stack.

The liquid hydride can selected from the group consisting of sodium borohydride (NaBH₄), lithium borohydride (LiBH₄), lithium hydride (LiH), sodium hydride (NaH), and mixtures thereof. In one embodiment, the liquid hydride fluid may be a NaBH₄ liquid and the liquid catalyst may be an aqueous acid solution. The acid may be selected from a group consisting of malic acid, succinic acid, oxalic acid, citric acid, acetic acid, hydrochloric acid, and combinations thereof.

In one embodiment, the fuel cell system may further include a first pump for transferring the liquid hydride to a first inlet of the reaction flow channel; a second pump for transferring the liquid catalyst to a second inlet of the reaction flow channel; and a controller for controlling the first and second pumps.

In one embodiment, the hydrogen separator may include a hydrogen supply pipe for transferring the hydrogen gas released from a gas-liquid membrane. The membrane may be located in the reaction flow channel of the fuel cell stack.

In one embodiment, the hydrogen separator may include a residual chamber coupled to an outlet of the reaction flow channel and a hydrogen supply pipe for transferring the hydrogen gas that is generated to the fuel cell stack.

According to one embodiment, the reaction flow channel may have a circular cross-section with a diameter of 2 mm or less. Alternatively, the reaction flow channel may a rectangular cross-section with a width to a length ratio ranging from 2:1 to 1:2. In one embodiment, the cross-sectional area of the reaction flow channel is 4 mm² or less. In another embodiment, the reaction flow channel includes two or more sub-channels.

In one embodiment, the fuel cell system has at least one liquid catalyst inlet adapted to promote laminar flow of the liquid catalyst and at least one liquid hydride inlet that is located within the reaction flow channel and spaced from an inner wall of the reaction flow channel. In one embodiment, the liquid hydride inlet is downstream of the liquid catalyst inlet.

In one embodiment, the fuel cell system has a plurality of liquid catalyst inlets and at least one liquid hydride inlet. The liquid hydride inlet is sandwiched between or is between the plurality of the liquid catalyst inlets. According to such an embodiment, two boundary surfaces are provided between the liquid catalyst and the liquid hydride.

The reaction flow channel is not limited to fuel systems. In one embodiment, the reaction flow channel can be used for transferring a first liquid and a second liquid. The flow channel includes a first inlet adapted to promote laminar flow of the first liquid and a second inlet located downstream of the first inlet and spaced from an inner wall of the flow channel. The second inlet is also adapted to promote laminar flow of the second liquid. According to such an embodiment, the second liquid is surrounded by the first liquid and has a boundary perimeter located in a middle of the flow channel and spaced from an inner wall of the flow channel. The flow channel may have a circular cross-section with diameter of 2 mm or less.

### BRIEF DESCRIPTION OF THE DRAWINGS

These and/or other embodiments and features of the invention will become apparent and more readily appreciated from the following description of certain exemplary embodiments, taken in conjunction with the accompanying drawing of which:

FIG. 1 is a schematic view of a fuel cell system according to an embodiment of the present invention;

FIGS. 2A to 2C illustrate top views and cross-sectional views of reaction flow channels according to embodiments of the present invention;

FIG. 3 is a schematic view of a hydrogen separator according to an embodiment of the present invention;

FIG. 4 is a schematic view of another hydrogen separator according to an embodiment of the present invention; and

FIG. 5 is a schematic view of a liquid pumping mechanism according to an embodiment of the present invention

### DETAILED DESCRIPTION OF EXEMPLARY EMBODIMENTS

Hereinafter, certain exemplary embodiments according to the present invention will be described with reference to the accompanying drawings. Here, elements that are not essential to the complete understanding of the invention are omitted for clarity. Also, like reference numerals refer to like elements throughout.

In the following embodiment, a fuel cell system using sodium borohydride (NaBH₄) as a hydride is explained, however, it is understood that other hydrides such as lithium borohydride (LiBH₄), lithium hydride (LiH), and sodium hydride (NaH) can also be used as the fuel, and such embodiments are also within the scope of the present invention.

The phrase “fuel cell stack” as used in the description of the present invention refers to a typical fuel cell stack that includes one or more unit cells arranged in a stacked configuration. Such a fuel cell stack is shown schematically in the drawing figures here as a fuel cell stack configured with a single unit cell, but such a schematic representation is intended to represent any fuel cell stack configuration.

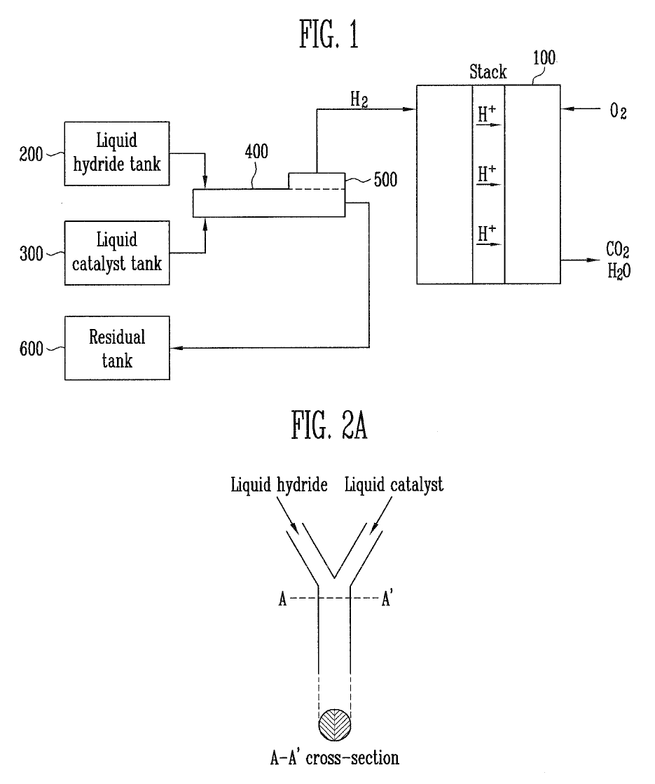

FIG. 1 is a schematic view of a fuel cell system according to an embodiment of the present invention. The fuel cell system in this embodiment is specified as using NaBH₄ liquid as a hydride fuel.

An aqueous acid solution is used as a liquid catalyst for promoting a reaction for generating hydrogen from NaBH₄. Suitable acids include one or more of malic acid, succinic acid, oxalic acid, citric acid, acetic acid, and hydrochloric acid.

The fuel cell system of FIG. 1 includes a fuel cell stack 100 for generating electricity by means of an electrochemical reaction between hydrogen and oxygen; a liquid hydride tank 200 storing liquid hydride such as NaBH₄ liquid; a liquid catalyst tank 300 for storing a liquid catalyst for promoting a reaction that generates hydrogen from the liquid hydride; and a reaction flow channel 400 for promoting laminar flow of the liquid hydride and the liquid catalyst.

In the reaction flow channel 400, the liquid hydride and the liquid catalyst are mixed at their boundary surface. A hydrogen generation reaction of NaBH₄ occurs according to the following chemical formula 1.

NaBH₄+2H₂O→NaBO₂+4H₂+Q [Chemical formula 1]

where Q is heat.

A hydrogen separator 500 is provided for storing hydrogen generated according to the chemical formula above and for transferring the hydrogen to the fuel cell stack. The hydrogen separator 500 may be located around the reaction flow channel 400. The hydrogen from the hydrogen separator 500 is supplied to an anode electrode of the fuel cell stack 100 to be used as a fuel.

Hydrides such as NaBH₄ are reactive with water, even without the liquid catalyst. Therefore, in one embodiment, NaBH₄ is maintained at high concentrations within the limits of viscosity. The liquid catalyst should supply sufficient water required by the chemical formula 1 as well as a sufficient amount of the catalyst material. Therefore, the liquid catalyst may be provided at low concentrations.

The residual tank is for storing NaBO₂, which is also in an aqueous liquid fluid state, and which is generated according to the chemical formula 1.

The liquid hydride tank, the liquid catalyst tank, and the residual tank may be manufactured or formed as a single, integral cartridge container. As the volume of the liquid hydride tank and/or the liquid catalyst tank decreases based on use of the liquid, the volume of the residual tank expands to accommodate the NaBO₂ that is generated.

Although not shown, the fuel cell system may further include a power conversion unit for transferring the power generated from the fuel cell stack 100 to an external load and/or a secondary battery for storing the power generated from the fuel cell stack 100.

In one embodiment, oxygen is supplied to a cathode of the fuel cell stack 100 in a passive manner. That is, ambient air is allowed to flow or circulate to the cathode. In another embodiment, oxygen is supplied to the cathode using an air pump.

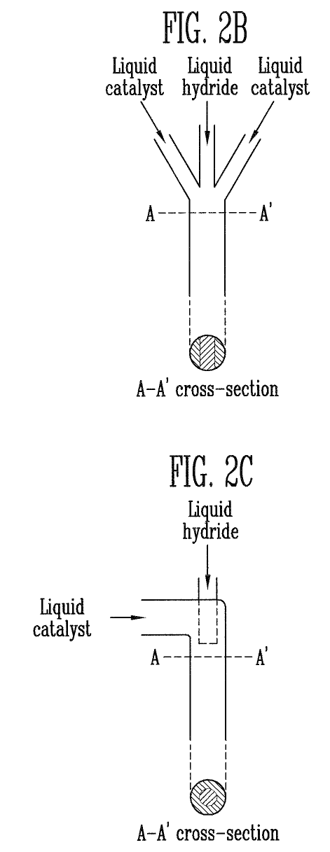

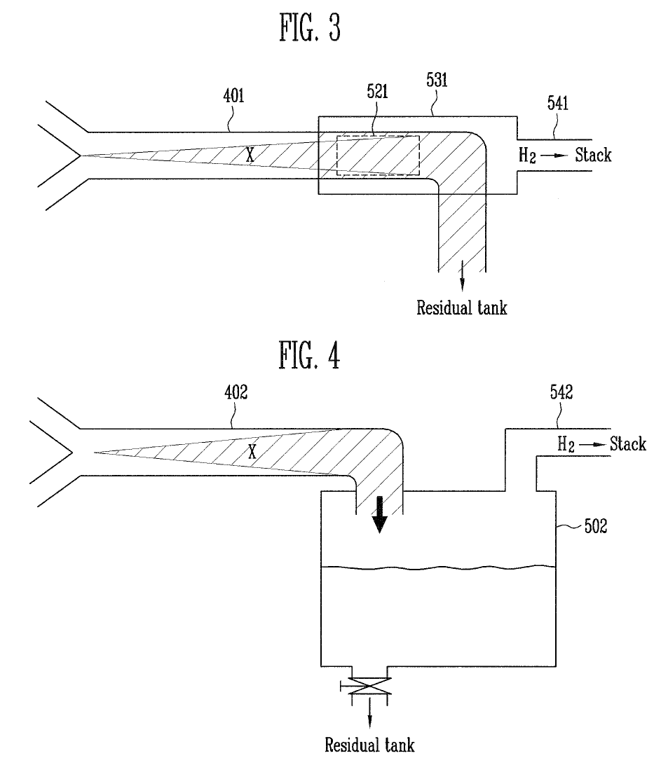

FIGS. 2A to 2C show flow channels in cross-section according various embodiments of the present invention. The reaction flow channel as shown in FIGS. 2A to 2C promote laminar flow of the two liquids conveyed inside thereof. In one embodiment, the reaction flow channel may have a circular cross-section with a diameter of about 2 mm or less or a rectangular cross-section having a width to length ratio ranging from 2:1 to 1:2. The rectangular cross-section may have a cross-sectional area of 4 mm² or less.

The reaction flow channel of FIG. 2A has the simplest structure. Referring to FIG. 2A, a liquid hydride flows into a first inlet and a liquid catalyst flows into a second inlet creating laminar flow of which a circular cross-section illustrates a vertical boundary surface. In order to stabilize the laminar flow, the liquid hydride with a higher specific gravity should be located below, and the liquid catalyst with a lower specific gravity should be located above. In one embodiment, the first inlet may be located below the second inlet.

The reaction flow channel of FIG. 2B has three inlets, where a liquid hydride flows into the inlet located in the middle. A liquid catalyst flows into the two remaining inlets located on both sides of the middle inlet. The reaction flow channel allows the flow of the liquid catalyst to be located on both sides of the flow of the liquid hydride. As a result, the contact surface between the liquid hydride and an inner wall of the flow channel can be minimized, and in one embodiment, the contact surface is smaller than that of the embodiment of FIG. 2A. In that way, flow resistance and/or pressure drop caused by the viscous liquid hydride can be reduced.

In the reaction flow channel of FIG. 2C, a first inlet for a liquid catalyst is provided to form a flow path. A second inlet for a liquid hydride is then provided in the middle of the path where the liquid catalyst flows. As shown in FIG. 2C, the laminar flow of the liquid catalyst allows the liquid hydride to be injected therein, hence the liquid catalyst flow surrounds the liquid hydride flow. In this embodiment, the liquid catalyst always exists between the liquid hydride and the reaction flow channel inner wall. Therefore, contact between the highly viscous liquid hydride and the reaction flow channel inner wall is minimized or eliminated, improving the flow characteristics.

The reaction flow channel of FIG. 2C may also be useful in other applications for transporting two liquids having different characteristics. As used hereafter, the reaction flow channel as shown in FIG. 2C may be referred to as a flow channel and various applications related to the flow channel will be further described.

The flow channel of FIG. 2C includes a first inlet where a first liquid having a first characteristic flows forming a flow path. The flow channel also includes a second inlet that is located in the middle of the flow channel so that a second liquid fluid having a second characteristic can be injected to flow into the middle of the flow path.

In certain embodiments, the flow channel is useful for transporting viscous liquids having a high flow resistance with the flow channel inner wall and another liquid having a lower flow resistance. In other words, if a highly viscous liquid is moved to middle of the flow channel as shown in FIG. 2C, there will always be a liquid having a lower viscosity existed between the channel inner wall and the highly viscous liquid, making it possible to decrease or prevent contact between the flow channel inner wall and the highly viscous liquid. In this way, the highly viscous liquid can still have a smooth and efficient flow in the flow channel.

FIG. 3 shows one embodiment of a hydrogen separator used in a fuel cell system according to the present invention.

The hydrogen separator of FIG. 3 includes a liquid-gas separating membrane 521, a trapping chamber 531, and a hydrogen supply pipe 541. The gas-liquid separating membrane 521 is located in a reaction flow channel 401 of a fuel cell system. The trapping chamber 531 stores the hydrogen gas released from the gas-liquid separating membrane 521, and the hydrogen supply pipe 541 transfers the hydrogen from the trapping chamber 531 to the fuel cell stack.

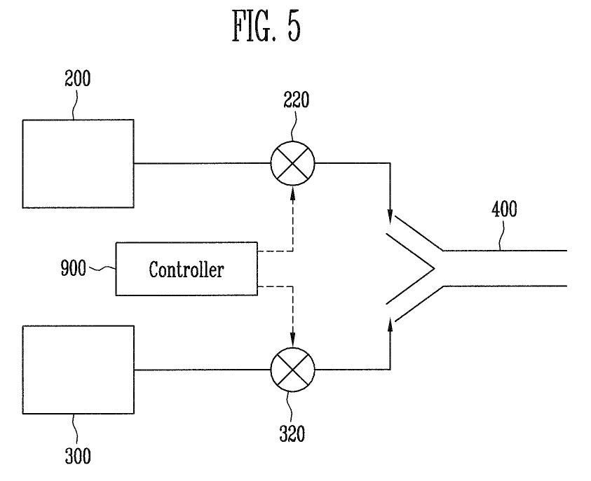

As both the liquid hydride and the liquid catalyst have laminar flow inside a reaction flow channel 401, as previously discussed, boundary surface(s) between liquids is maintained. Also as previously discussed, the hydrogen generation reaction as shown in the chemical formula 1 occurs at the boundary surface. As a result, a reaction region indicated as X increases as the boundary surface between liquids increases. As shown in FIGS. 3 and 4, the X region increases in the direction of flow. The generated hydrogen gas in the X region is released through the gas-liquid separating membrane 521. Residues of the reaction including NaBO₄, which is a by-product of the chemical formula 1, flow to the end of the reaction flow channel 401 and are transferred to a residual tank.

The hydrogen gas released from the gas-liquid separating membrane 521 is stored in the trapping chamber 531. The hydrogen gas is then transferred to the fuel cell stack through the hydrogen supply pipe 541.

FIG. 4 shows another hydrogen separator used in a fuel cell system according to another embodiment of the present invention.

The hydrogen separator of FIG. 4 incorporates a hydrogen supply pipe 542 for transferring the generated gas that rises to the upper region of the separator. In an embodiment, the hydrogen separator is a gas-liquid separating chamber 502 for temporarily storing fluids that exit from the reaction flow channel.

Hydrogen gas generated in the reaction flow channel 402 in the X region and the produced residues including NaBO₄ flow into the gas-liquid separating chamber 502. In the gas-liquid separating chamber 502, light gas components, which mainly consist of hydrogen gas, rise upwardly. Whereas, residues including NaBO₄ residues settle and are accumulated at the bottom of the gas-liquid separating chamber 502. The residues are then transferred to a residual tank. The generated hydrogen gas in the upper region of the gas-liquid separating chamber 502 is then transferred to the fuel cell stack through the hydrogen supply pipe 542.

The reaction flow channel according to an embodiment of the present invention has a diameter of 2 mm or less so that the liquid hydride and the liquid catalyst can form laminar flow. Since it is difficult to rely only on one channel having a diameter of 2 mm or less to transfer a sufficient amount of fluid needed by a fuel cell, a plurality of the reaction flow channels may be provided to transfer a larger volume of fluid. In one embodiment, each flow channel may include a plurality of sub-channels having a diameter of 2 mm or less.

When there is laminar flow of the liquid hydride and the liquid catalyst, residues that are produced from the reaction are carried out of the reaction flow channel flow. However, if the operation of the fuel cell system stops for a long period of time due to a power-off scenario, for example, the reaction of the chemical formula 1 may occur in the reaction flow channel after the flow of the fluids stops. As a result, the reaction flow channel may be blocked by the residues generated from the reaction.

A fuel cell system of FIG. 5 may be provided to address such a problem. In one embodiment, the fuel cell system may include a pump system that has a first pump 200 for pumping a liquid hydride from a liquid hydride tank 200 to an inlet of a reaction flow channel 400, a second pump 320 for pumping a liquid catalyst from a liquid catalyst tank 300 to another inlet of the reaction flow channel 400, and a controller 900 for controlling the first pump 220 and the second pump 320.

In certain embodiments, in order to prevent a residue blockage in the reaction flow channel 400, the controller 900 receives and responses to a power-off command of the fuel cell system. In one embodiment, the controller 900 does not immediately stop the operation of the pumps 220 and 320 simultaneously. But rather, the controller 900 first stops the pump 220 that supplies the liquid hydride. The controller 900 may be programmed to allow the pump 320 that supplies the liquid catalyst to continue on for a set period time before stopping the pump 320. In one embodiment, the set period of time may be determined by the time it takes to empty the liquid hydride inside the reaction flow channel by the flow of the liquid catalyst.

Alternatively, a vacuum pump may be provided to draw out the liquids inside the reaction flow channel. In this embodiment, although the controller 900 receives a power-off command from the fuel cell system, the vacuum pump may continue to operate for a period of time until all the liquid hydride inside the reaction flow channel is emptied.

Accordingly, various embodiments of a fuel cell system of the present invention can minimize and/or prevent blockage to the flow channel of the liquid of the system.

In particular, various embodiments of the present invention can minimize and/or prevent blockage to the flow channel, while maintaining a sufficient reaction area for the liquid hydride and the liquid catalyst.

Although exemplary embodiments of the present invention have been shown and described, it would be appreciated by those skilled in the art that changes might be made in these embodiments without departing from the principles and spirit of the invention, the scope of which is also defined by the claims and their equivalents.

What is claimed is:

1. A fuel cell system comprising:
a fuel cell stack adapted to generate electric energy by an electrochemical reaction between hydrogen and oxygen;
a hydride tank adapted to store a liquid hydride;
a liquid catalyst tank adapted to store a liquid catalyst for promoting a reaction that generates hydrogen gas;
a reaction flow channel comprising at least one liquid hydride inlet and at least one liquid catalyst inlet and adapted to promote laminar flow of the liquid hydride and the liquid catalyst and generate hydrogen gas by a reaction between the liquid hydride and water; and
a hydrogen separator adapted to store the hydrogen gas generated from the reaction flow channel and to transfer the hydrogen gas to the fuel cell stack.

2. The fuel cell system of claim 1, wherein the liquid hydride is selected from the group consisting of sodium borohydride (NaBH₄), lithium borohydride (LiBH₄), lithium hydride (LiH), sodium hydride (NaH), and mixtures thereof.

3. The fuel cell system of claim 2, wherein the liquid hydride is a NaBH₄ liquid.

4. The fuel cell system of claim 1, wherein the liquid catalyst comprises an aqueous acid solution, wherein the acid is selected from the group consisting of malic acid, succinic acid, oxalic acid, citric acid, acetic acid, hydrochloric acid, and combinations thereof.

5. The fuel cell system of claim 1, further comprising
a first pump adapted to transfer the liquid hydride to the at least one liquid hydride inlet of the reaction flow channel; and a second pump adapted to transfer the liquid catalyst to the at least one liquid catalyst inlet of the reaction flow channel.

6. The fuel cell system of claim 5, further comprising a controller that controls the first and the second pumps.

7. The fuel cell system of claim 1, wherein the hydrogen separator comprises a hydrogen supply pipe adapted to transfer hydrogen gas released from a gas-liquid membrane in the reaction flow channel to the fuel cell stack.

8. The fuel cell system of claim 1, wherein the hydrogen separator comprises a residual chamber coupled to an outlet of the reaction flow channel and a hydrogen supply pipe adapted to transfer the generated hydrogen gas to the fuel cell stack.

9. The fuel cell system of claim 1, wherein the reaction flow channel has a circular cross-section with a diameter of 2 mm or less.

10. The fuel cell system of claim 1, wherein the reaction flow channel has a rectangular cross-section with a cross-sectional area of 4 mm² or less.

11. The fuel cell system of claim 10, wherein the rectangular cross-section has a width to length ratio ranging from 2:1 to 1:2.

12. The fuel cell system of claim 1, wherein the reaction flow channel comprises two or more sub-channels.

13. The fuel cell system of claim 1, wherein the at least one liquid hydride inlet is located within the reaction flow channel and spaced from an inner wall of the reaction flow channel.

14. The fuel cell system of claim 13, wherein the at least one liquid hydride inlet is downstream of the at least one liquid catalyst inlet.

15. The fuel cell system of claim 1, wherein the reaction flow channel comprises a plurality of liquid catalyst inlets and the at least one liquid hydride inlet is located between the plurality of the liquid catalyst inlets.

16. The fuel cell system of claim 1, wherein the reaction flow channel comprises a liquid hydride inlet located in a middle of two liquid catalyst inlets and adapted promote two boundary surfaces between the liquid catalyst and the liquid hydride.

17. A flow channel for transferring a first liquid and a second liquid, the flow channel comprising:
a first inlet adapted to promote laminar flow of the first liquid; and
a second inlet located downstream of the first inlet and spaced from an inner wall of the flow channel, wherein the second inlet is adapted to promote laminar flow of the second liquid, and wherein the first and second liquids form a generally circular boundary layer located in a middle of the flow channel.

18. The flow channel of claim 17, wherein the flow channel has a circular cross-section with a diameter of 2 mm or less.
